(19) United States
(12) Patent Application Publication
(10) Pub. No.: US 2025/0321026 A1
(43) Pub. Date: Oct. 16, 2025

(54) PATENT US 11,121,667 B2

(71) Applicant: Paolo Pietro Petrachi, St Petersburg, FL (US)

(72) Inventor: Paolo Pietro Petrachi, St Petersburg, FL (US)

(21) Appl. No.: 18/634,900

(22) Filed: Apr. 13, 2024

(51) Int. Cl. F24S 25/61; F24S 25/20; F24S 25/632; F24S 25/636; F24S 25/65

(52) U.S. Cl. CPC F24S 25/61; F24S 25/20; F24S 25/632; F24S 25/636; F24S 25/65

(57) ABSTRACT

A method and railing assembly for efficiently securing aluminum framed solar panels on a roof surface that does not require penetration of the roof membrane. The railing assembly comprises lightweight aluminum extrusions8. The outer rails are extruded with a single groove on the lower side, while the inner rails are for connecting these outer rails. The railing assembly low profile design, coupled with perimetral skirting elements positioned around the base, facilitates unobstructed water drainage across the aluminum components. Additionally, the assembly boasts an aerodynamic configuration that minimizes wind resistance during high wind events.

### CROSS REFERENCE TO RELATED APPLICATION

This application claims priority to provisional application Ser. No. 63/457,744

### BACKGROUND OF THE INVENTION

### 1. Field of the Invention

This invention relates to roof mounted solar panels. More specifically, it relates to a method and railing assembly for mounting solar panels on pitched roofs with asphalt shingles.

### 2. Description of the Prior Art

There is a need for a sloped roof solar panel mounting system that attaches to rafters or roof supporting members, avoids penetrating the roof membrane, and is universal.

Solar panels must be secured to the roof and underlying structure to disperse wind and snow loads into the building structure. Although some mounting systems avoid using rails attach to the roof decking, they do not attach to the roof rafters because the spacing of rafters is different than the length of solar panel modules.

There is a need for solar panel mounting system to be adjustable for mounting to any solar panel module on the market, giving installers the flexibility to choose the solar panels module of their choice, rather titan be required to buy a module with custom profile rail, or the like, to accommodate the mounting system.

The gravity loads of the solar panels can magnify the uniform loads existing on the roof by concentrating them as point loads. The same holds true for wind loading, as the wind uplift is accumulated through the solar array and directed to the posts that support the solar panel. In order to minimize the amount of time and money spent on structural and uplift calculations it is desirable to have a solar panel mounting system which can secure solar panel modules to the roof without overloading the roof trusses with single point load.

It is also desirable to have a solar panel mounting system which can secure solar panel modules to the roof without penetrating the roof membrane and it can function as both a structural stabilizer and an energy-generating component.

### BRIEF DESCRIPTION OF THE DRAWINGS

FIG. 1 provides a view of the railing and clamp assembly for solar panels installed on a roof surfaced with 3-tab shingles.

FIG. 2 illustrates a railing and clamp assembly for solar panels on a 3-tab shingle roof, incorporating perimetral skirt elements.

FIGS. 3, 3a, and 3b depict a sequence of front view illustrations demonstrating the step-by-step process for installing the stainless steel locking clip member 60 into the outer rail member 54, using a spatula 40 as a tool.

FIGS. 4, 4a, and 4b depict a series of perspective views illustrating the sequential installation process for the stainless steel locking clip member 60, aided by a spatula 40, into the outer rail member 54.

FIG. 5 depicts a perspective view of the stainless steel locking clip 60. The figure illustrates the clip being inserted into the outer rail member 54 on a sloped roof surface covered with architectural shingles.

FIGS. 6 and 6a illustrates a side view of the initial step of the clip insertion process.

FIG. 7 depicts a side closeup view of the railing assembly and solar panel assembly.

FIG. 7c illustrates a detail view of the center location of the drainage hole 53 incorporated within each outer rail member 54.

FIG. 8 presents a side-view illustration of the fascia anchor member 20.

FIG. 8a provides a complementary side-view illustration depicting the assembled components

FIG. 8b depicts a perspective view of the fascia anchor member 20

FIGS. 9 and 9a represent a perspective view of FIG. 8 and FIG. 8a.

FIG. 9b depicts a perspective view of the lower right corner of the complete rail assembly 50 attached to the fascia 5 and the roof 4.

FIG. 10 depict a perspective view of a 3 dimensional (3D) skirt lock member.

FIG. 11 offers a perspective-view illustration of the disassembled components that comprise the mid skirt anchor 29.

FIG. 11a provides a complementary detail view of the mid skirt anchor member 29 integrated with all its components.

FIG. 11b provides a close-up perspective view of the mid skirt anchor 29.

FIG. 11c illustrates a detail side view of the complete rail assembly. This view showcases the mid skirt anchor member 29 fully integrated within the assembly.

FIG. 12 offers a rear perspective view of the stainless steel clip 60

FIG. 12a presents a front perspective view of the stainless steel clip 60

FIG. 12b provides a side view of the stainless steel clip 60

FIG. 13 depicts a perspective exploded view of the prep tool 48, with all its stainless steel components, including the base 43, the guides 42, flat head bit 45, a V groove roller wheel 47 and a locking pin 46

FIG. 13a presents a perspective view of a complete assembly of the prep tool 48 and all the tool's constituent components in their fully assembled state.

FIG. 13b provides a perspective view of the prep tool 48 in position on the shingle's end flap to create the seam 8

FIG. 13c offers a close-up side view of the seam 8 creation process.

### DETAILED DESCRIPTION OF THE PREFERRED ASSEMBLY

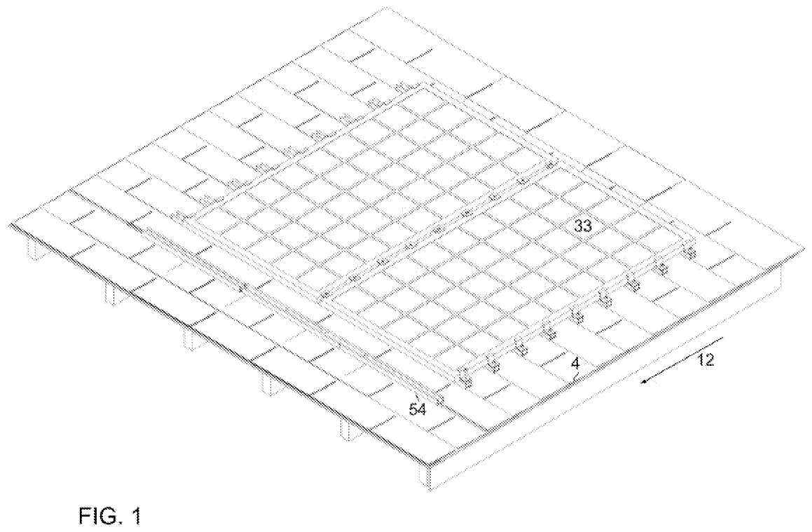

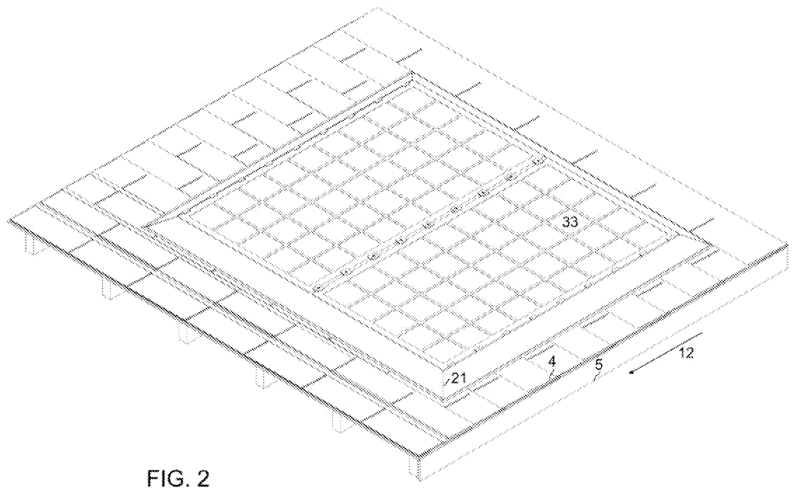

Referring to FIGS. 1 and 2, the railing assembly, is shown positioned on a roof 4. The railing assembly is essentially a rail or frame for securing one or a multitude of solar panels 33 to a sloped roof 4.

A key aspect of the invention is that railing assembly can be mounted without penetrating the roof membrane, which greatly reduces the probability of leaks.

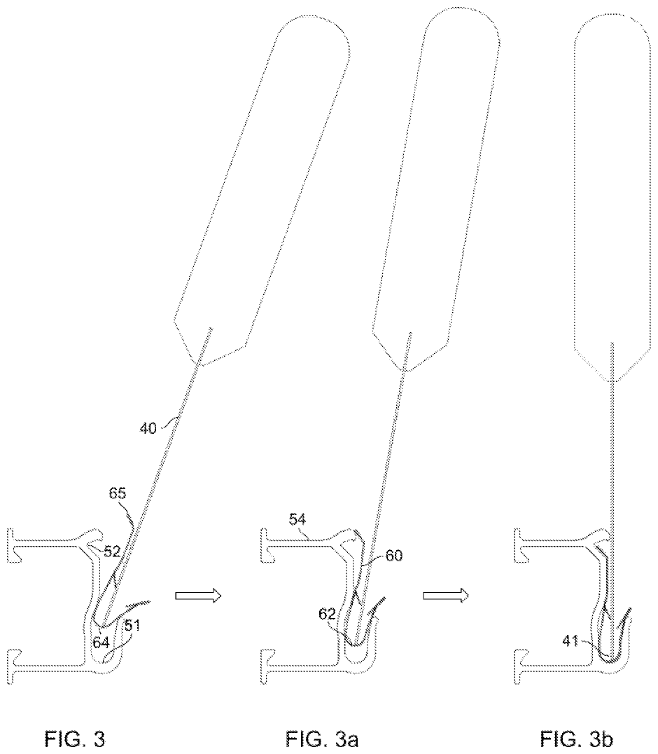

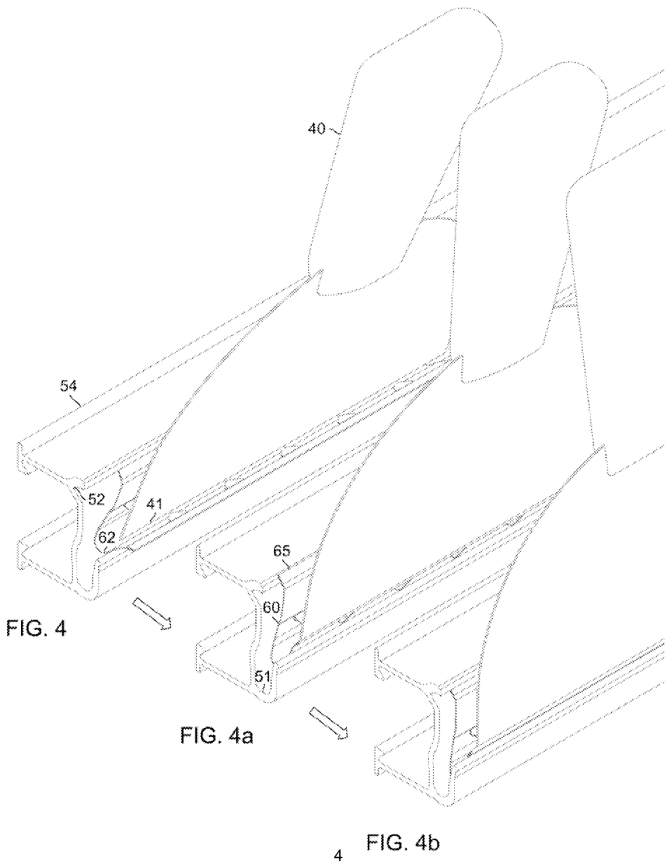

Referring to FIGS. 3, 3a, 3b as front view and 4, 4a, 4b as perspective view, it is shown, in 3 illustrated sequential steps, how to install the stainless steel locking clip 60 on the outer rail 54. In detail in FIG. 3 and FIG. 4 show the outer rail 54 laid on the side with the groove facing up, the clip 60 positioned with back of clip 64 on the top part of the groove of the outer rail 54 and a spatula 40 positioned longitudinally to the clip 60 and touching the groove end 62 with the spatula edge 41. FIGS. 3b and 4b depicts the final position of the stainless clip 60 fully inserted with its back 64 touching the back of the lower groove 51 of the outer rail 54 and the clip tongue 65 snapped into the outer rail front groove 52.

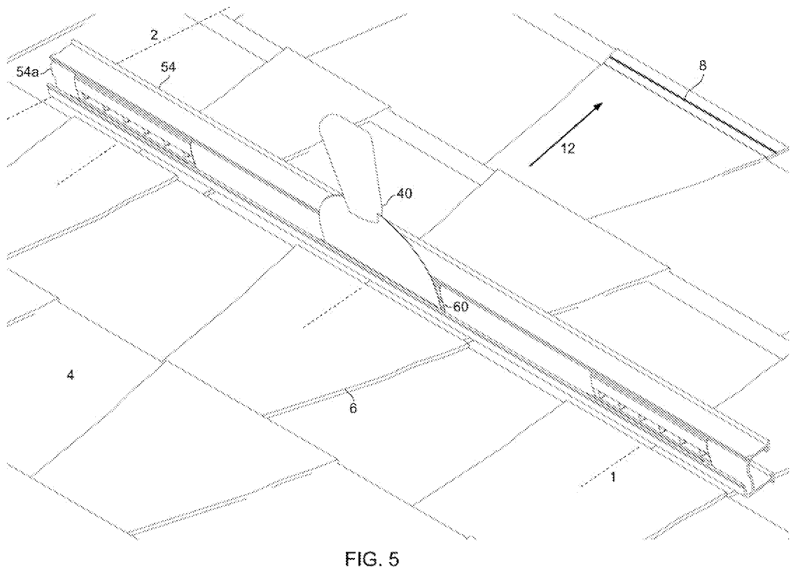

As illustrated in FIG. 5, the roof installation process commences with the initial alignment of the clips 60 that are inserted into the outer rail 54. Before this insertion, the edge 54a of the outer rail have to be flush with the edge 2 of the future completed assembly. Following the alignment, the central portion 1 of each clip 60 is aligned with the corresponding center 1 of its respective slate shingle 6.

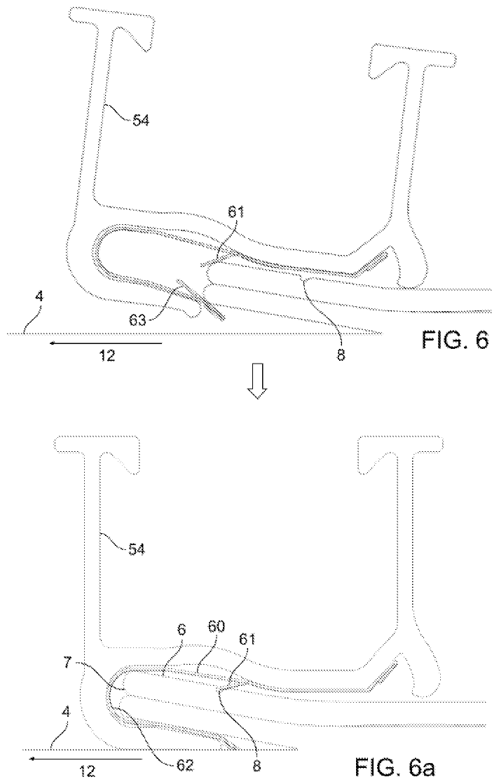

FIG. 6 represent the first step in which the outer rail 54 and the stainless steel locking clip 60 is positioned on an angle compared to the roof 4, using the base of the roof 4 as a guide, opposite direction of slope 12 and pushing the outer rail 54, and during this pressing action, the end flap 7 of the shingle directly contacts the groove end 62.

FIG. 6 illustrates the initial step of the clip insertion process. This step involves the positioning of the outer rail member 54 and the stainless steel locking clip member 60 at an angled orientation relative to the roof surface 4 and opposite direction relative to the existing roof slope 12.

FIG. 6a shows the designated end flap 7 of the shingle directly contacts the designated groove 62 of the clip 60. As the outer rail 54 is pressed into its final locked position, the lower tooth 63 punctures the lower portion of the slate shingle 6. Simultaneously, the upper tooth 61 snaps into a detented position on the seam 8 of the slate shingle.

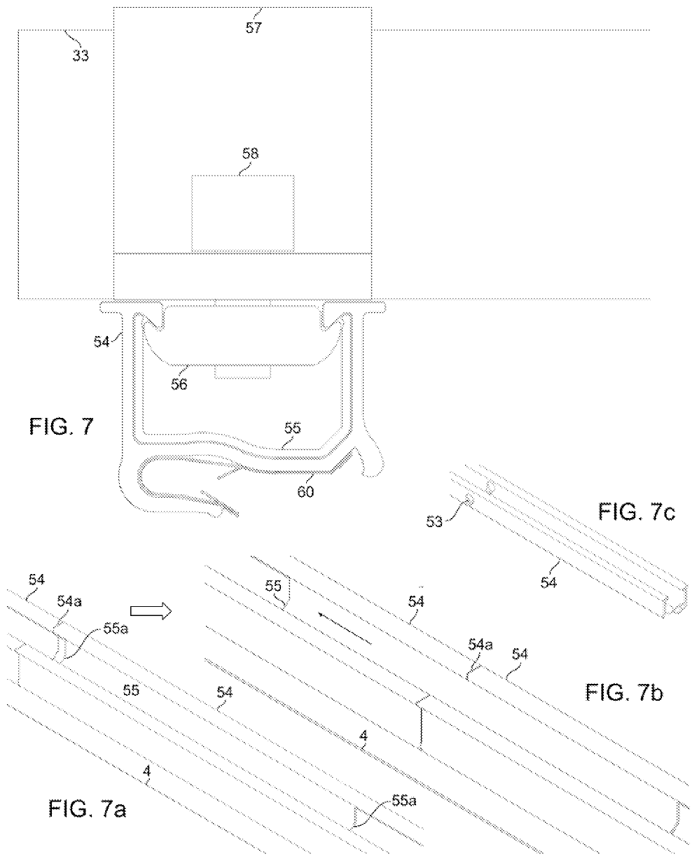

FIGS. 7a and 7b depict the railing assembly, specifically highlighting its modular design. This modularity is evident in the assembly process, which facilitates the connection of multiple outer rail members 54 along the roof's longitudinal axis. The inner rails 55 function is to facilitate the longitudinal connection of multiple outer rails 54 along the course of the shingles. This is achieved through the use of outer rails 54 with variable lengths ranging from 500 millimeters to 700 millimeters. These outer rails can be interconnected using inner rails 55, each with a fixed length of 300 millimeters.

FIG. 7a is a perspective view depicting the initial stage of the inner rail 55 connection process. The figure depicts two outer rails 54 joined along the course of the shingles on roof 4. Notably, one of these outer rail members 54 houses a pre-cut inner rail 55. This inner rail member is positioned with its edge 55a in proximity to the edge 54a of the outer rail 54.

FIG. 7b then depicts the subsequent stage of the connection process. Here, the pre-cut inner rail 55 is shown partially inserted between the two opposing edges 54a of the outer rail 54.

FIG. 7 presents a side-perspective illustration of the railing assembly 50. This view depicts the assembly configured to support a mounted solar panel 33. The panel is secured using a standard clamp 57, which is connected to the outer rail 54. Notably, an inner rail member 55 is inserted. The connection is finalized and secured with a standard nut 56 and bolt 58. Additionally, the figure illustrates the stainless steel locking clip 60 positioned within the outer rail 54.

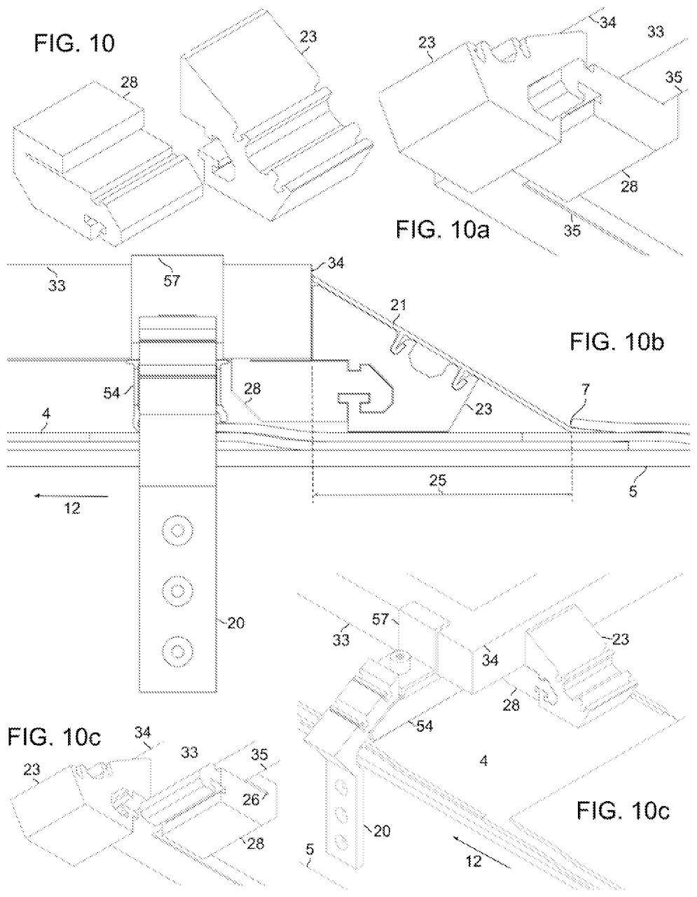

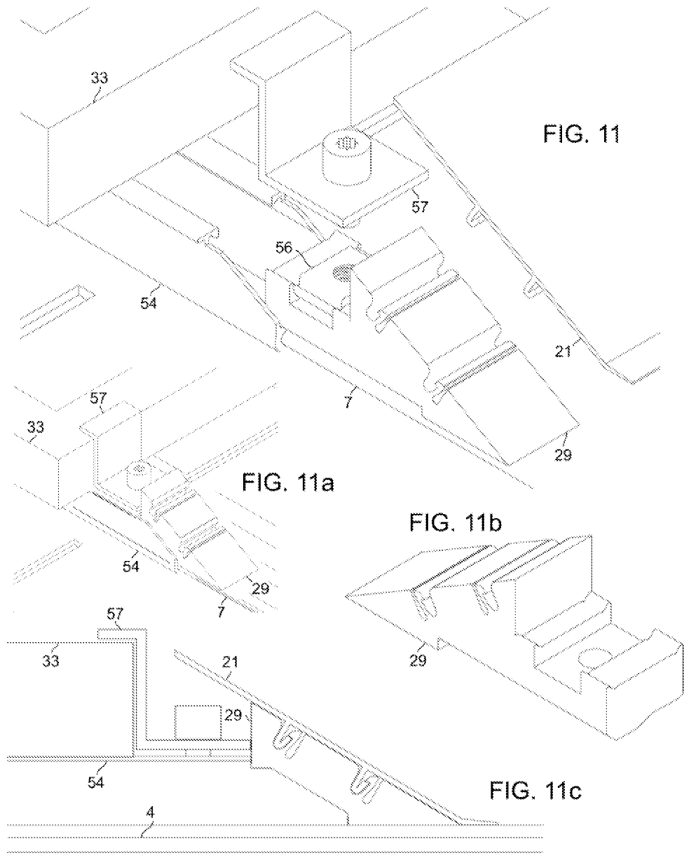

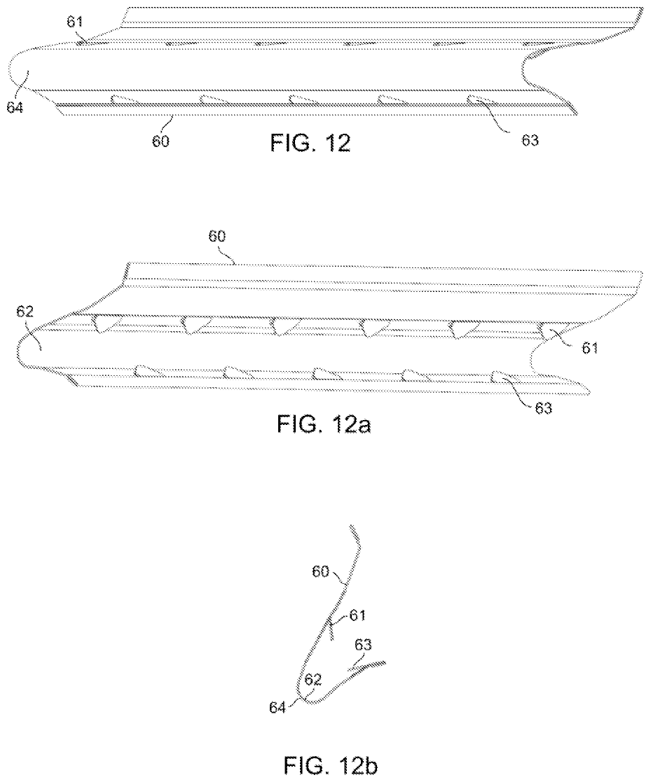

The first solar panel 33 can be installed on the railing assembly 50 once a sufficient initial section of the assembly has been completed to fully support the panel's footprint on the roof surface 4. As illustrated in FIG. 10b, the installation process for the first panel involves the initial alignment of the top edge 34 of the solar panel 33. The solar panel is positioned at a predetermined distance 25 relative to the end flap 7 of the next shingle course located in opposition to the roof slope 12.

In this specific scenario as is shown on FIG. 10b, a predetermined distance 25 of 85 millimeters is maintained between the end flap 7 of the shingle and the top edge 34 of the solar panel 33.

Prior to installing the uppermost solar panels 33, a plurality of three-dimensional 3D skirt lock member 23 and perimetral flange groove member 28 must be secured to the top and bottom frame of each panel.

FIG. 10c details the subsequent step. Here, the 3D perimetral flange lock member 28 is inserted by sliding beneath the top or bottom frame of the solar panel 33. This sliding motion facilitates engagement between the perimetral flange 35 and the groove 26 within the 3D skirt lock member 28. Next step is to slide longitudinally the counter skirt lock 23 into the perimetral flange lock 28 as is shown in FIG. 10a.

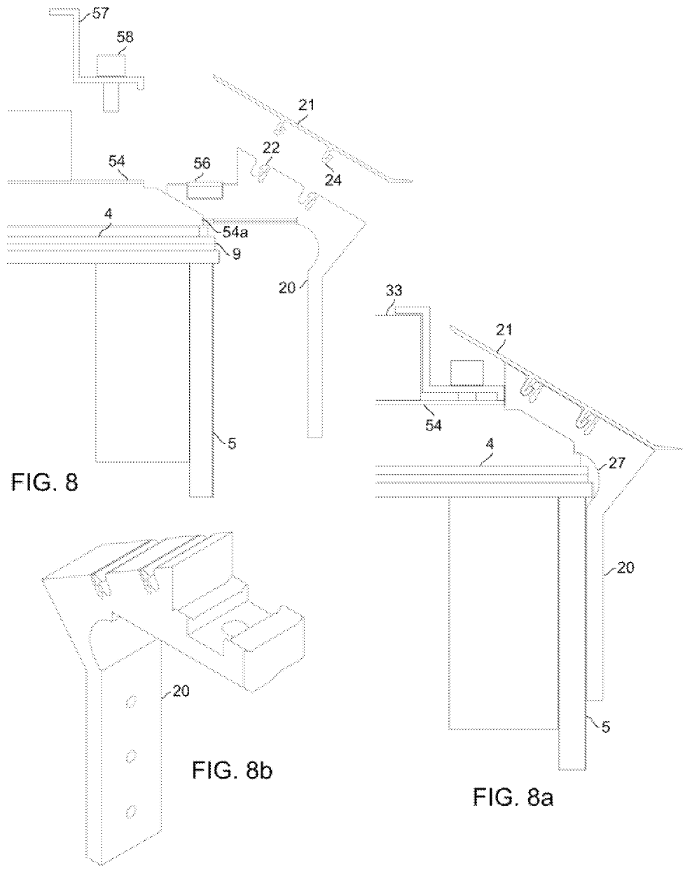

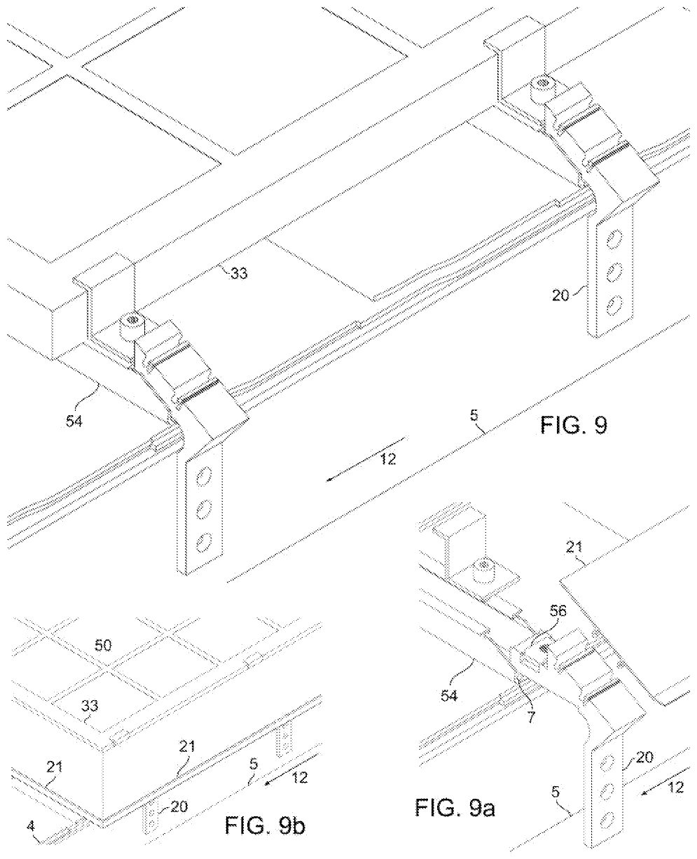

FIG. 8 presents a side-view illustration of the fascia anchor member 20 positioned for sequential attachment to the outer rail member 54, followed by the skirt member 21. As an initial step, the outer rail member edge 54a is situated in close contact with the drip edge 9 of the roof surface 4 along the fascia board side 5.

FIG. 8a provides a complementary side-view illustration depicting the assembled components in their final, secured positions. This view showcases the drip edge, fascia board, fascia anchor member 20, skirt member 21, outer rail member 54, and the solar panel 33 securely locked in place.

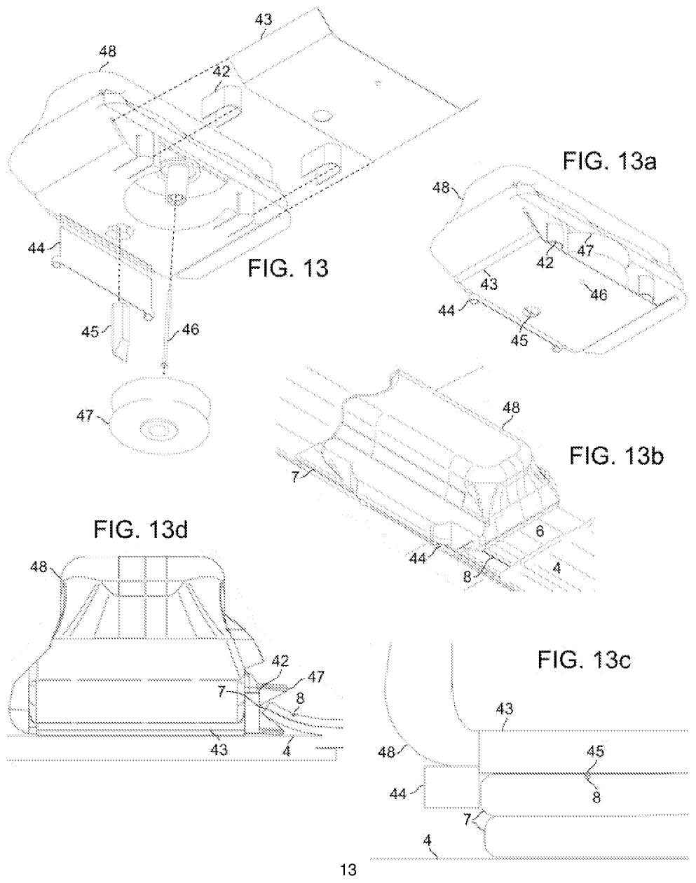

Prior to attaching each outer rail member 54 to the roof surface 4, the corresponding end flap 7 of the shingle must be prepped, using a prep tool shown on FIG. 13a, to facilitate a smooth installation process.

As is shown on FIG. 13d the end flap 7 is curved upwards using a V groove roller wheel 47 and a guide 42 of the prep tool 48. This creates the necessary clearance to allow the outer rail member 54 to be slid underneath the end flap 7 and rolled along the shingle's course.

Asphalt shingles exhibit a susceptibility to variations in temperature. During colder weather conditions, these shingles tend to experience increased rigidity compared to their state in warmer climates. This change in material properties can present a challenge for the upper teeth 61 of the stainless steel clip member 60 to effectively penetrate the upper surface of the shingle's end flap.

FIGS. 13b and 13c depict the method for creating an optional longitudinal seam 8 on the upper side of the end flap 7 of the slate shingle (6). This seam facilitates the engagement of the stainless steel clip member 60 during the rail assembly process.

The figures illustrate the use of the designated seam creation tool 48, which features a flathead bit tip 45 and a seam guide (44).

The process involves sliding the seam creation tool 48 along the end flap 7 of the shingle's course. The flathead bit tip 45, guided by the seam guide 44, precisely carves the desired longitudinal seam within the end flap material.

This seam facilitate the proper engagement of the stainless steel clip 60 during the rail assembly process in cold climates. The placement of this seam aligns precisely with the designated pinching point formed by the upper teeth 61 of the stainless steel clip member 60.

To ensure optimal performance and durability, all 3D-printed members of this rail assembly are made using Acrylonitrile Styrene Acrylate (ASA), a material specifically chosen for its properties like UV resistance and high impact strength.

To assess wind resistance, a 3D-printed prototype of the solar panel mounting assembly underwent a wind uplift test TAS 114 J conducted by an accredited laboratory associated with the Florida Product Approval Board. The test results achieved a passing rating for the wind load requirements of Miami Dade County when the outer rail member 54 was installed on every shingle course beneath the area occupied by the solar panels. Based on the successful outcome of the TAS 114 J testing, the installation frequency of the outer rail member 54 can be reduced to every other shingle course in locations throughout Florida and the wider United States, excluding Miami Dade County.

### FIELD OF THE INVENTION

The present invention relates generally to solar panels and more particularly to an assembly and mounting system for a solar panel on a roof using 3-Tab and/or Architectural asphalt shingles.

### BACKGROUND OF THE INVENTION

Solar electric systems are the most environmentally friendly way of generating electricity. To provide such solar electric systems, typically there is a solar panel, which comprises a plurality of solar modules, which are coupled together. The solar panels are typically assembled directly on the roof of a building, assembled on the ground and then mounted on a roof of a building, or installed on a dedicated ground or pole-mounted frame.

3-Tab and Architectural asphalt shingles are the most popular roof covering system in the U.S. residential construction market due to their relatively low installation cost and range of aesthetic options. A shingle system consists of overlapping strips of asphalt-impregnated organic or glass fiber mats that function as a water-shedding skin for structural roof decking. Asphalt shingles manufactured after the 1950s usually have an adhesive asphalt-based sealant strip embedded on the top or lower surface of the shingle that adheres when the roof temperature exceeds the sealant's softening point. Architectural shingles are laid in overlapping rows, with each row lining up at the top edge of the shingle below it. This creates a visible area of 5⅝ inches (143 millimeters) for each shingle.

The assembly attaches directly to each shingle's course by anchoring the end flap of each shingle to the panel mounting system, the system relates to U.S. Pat. No. 11,121,667. The structural analysis of the panel mounting systems presently used on residential roofs are considered a non-uniform point load system since the wind uplift pressure during high winds on solar panels is concentrated at the individual rail base mounts. These concentrated loads on the rail base mounts can pose challenges for the structural integrity of the roof.

The present invention provides a railing assembly that functions as a uniform point load system. This is achieved by distributing the wind uplift pressure across each course of shingles directly beneath the solar panel surface. Furthermore, the railing assembly offers the advantageous capability of being directly secured to the fascia board. This feature provides enhanced protection against wind uplift by preventing the outermost layer of shingles from detaching during high winds.

The railing assembly exhibits versatility in its application. With adjustments to the relative dimensions of the assembly components, a skilled artisan or someone with ordinary knowledge in the relevant field, would readily recognize its adaptability for use with utility panels functioning as shade for the roof itself, or low-profile wind turbines.

The absence of penetrating fasteners, such as bolts or screws, streamlines the installation process. This translates to reduced labor requirements for workers, ultimately contributing to enhanced workplace safety by minimizing opportunities for repetitive strain injuries or accidental punctures.

The railing assembly is designed for compatibility with conventional, rigid solar panels possessing a thickness range of approximately 30 to 50 millimeters. Notably, the assembly boasts a low profile configuration, with a total height from the roof base falling within the range of 50 to 80 millimeters. This translates to a height that is roughly one-third that of competing mounting systems currently offered on the market.

I claim:

1. A railing assembly securing a multitude of solar panels to a sloped roof comprising:
A plurality of railing members spaced apart from one another, said railing members extending from one of the sides of said solar panels to the other side of said solar panels.
Wherein each railing member including a groove, and said groove is positioned on the lower end of said railing member,
wherein said groove of each railing member is configured to receive a plurality of stainless steel clips.
Wherein said stainless steel clips are configured to receive an end flap of an asphalt shingle of a different course.
Wherein said stainless steel clips comprises anchoring teeth configured to lock said end flap of the respective asphalt shingle.
Wherein said railing members are configured to anchor said solar panels to said sloped roof.

2. A solar panel assembly, comprising a solar panel having:
A left frame, a right frame, a top frame, and a bottom frame.
Wherein said top and bottom frames each comprise a perimetral flange adapted to function as a tongue.
Wherein the solar panel assembly, further comprising:
A first 3D printed member (A) having a groove configured to receive the tongue of at least one of the top or bottom perimetral flanges of the solar panel frame,
wherein the solar panel assembly, further comprising:
A second 3D printed member (B) configured to receive the 3D printed member (A) in a locking engagement.
Wherein member (A) and member (B) together form a combined member (C) locked in place relative to the top or bottom perimetral flange of the solar panel frame.
Wherein the combined member (C) further comprises an upper surface adapted to anchor an extruded aluminum skirt.

3. An extruded aluminum rail, with a defined inner profile, for solar assemblies mounted on sloped asphalt shingled roofs, comprising a 3D printed member having an outer profile substantially conforming to the defined inner profile of said extruded aluminum rail.
Wherein said 3D printed member comprise a cavity formed within a side and top area of the member, configured to receive a standard nut.
Wherein said 3D printed member has a configuration adapted to slide into the defined inner profile with said standard nut positioned within the cavity.
Wherein said 3D printed member further comprises an opposing side and top area configured to anchor an extruded aluminum skirt.
Wherein said 3D printed member includes a configuration adapted to attach to a side fascia of said sloped asphalt shingled roof.
